(19) United States
(12) Patent Application Publication
(10) Pub. No.: US 2023/0232504 A1
(43) Pub. Date: Jul. 20, 2023

(54) DOMESTIC APPLIANCE DEVICE

(71) Applicant: BSH Hausgeräte GmbH, Munich (DE)

(72) Inventors: Alberto Dominguez Vicente, Zaragoza (ES); Jorge Español Leza, Zaragoza (ES); Guillermo Lazaro Amatriain, Igries (ES); Antonio Muñoz Fumanal, Utebo (ES); Ramon Peinado Adiego, Zaragoza (ES); Jorge Tesa Betes, Zaragoza (ES); Jorge Villa Lopez, Jaca (Huesca) (ES)

(21) Appl. No.: 17/924,124

(22) PCT Filed: May 20, 2021
(86) PCT No.: PCT/EP2021/063457

§ 371 Date: Nov. 9, 2022

(30) Foreign Application Priority Data
Jun. 2, 2020 (EP) 20382471.9

(51) Int. Cl. H05B 6/06; H05B 6/04

(52) U.S. Cl. CPC H05B 6/062; H05B 6/04

(57) ABSTRACT

A household appliance device includes a control unit which is designed to control an induction target repetitively with a switching frequency and to supply the induction target with energy. The control unit is designed to modulate in an operating state through frequency modulation the switching frequency within a modulation period which corresponds to an integer multiple of a half period of a mains AC voltage.

The invention relates to a household appliance device as claimed in the preamble of claim 1 and a method for operating a household appliance device as claimed in the preamble of claim 12.

A household appliance device comprising a control unit which is provided to control an induction target repetitively with a switching frequency and to supply said induction target with energy is already known from the prior art. For minimizing electromagnetic interferences, in an operating state the control unit modulates the switching frequency within a modulation period which corresponds to a maximum of a half period of a mains AC voltage, by means of a frequency modulation. Due to the very short duration of the modulation period, carrying out the frequency modulation is associated with a high computational effort, which requires a use of high-performance application-specific integrated circuits, and thus is associated with increased expenditure.

The object of the invention, in particular but not limited thereto, is to provide a generic device with improved properties regarding efficiency. The object is achieved according to the invention by the features of claims 1 and 12, whilst advantageous embodiments and developments of the invention can be derived from the subclaims.

The invention is based on a household appliance device, in particular a cooking appliance device, comprising at least one control unit which is provided to control at least one induction target repetitively with a switching frequency and to supply said induction target with energy.

It is proposed that in an operating state the control unit modulates the switching frequency within a modulation period which corresponds to an integer multiple of a half period of a mains AC voltage, by means of at least one frequency modulation.

A generic household appliance device having improved properties regarding a safe and/or convenient operation, in particular a low-noise operation and/or in particular regarding a compliance with EMC standards and/or a flicker conformity, can be provided with greater efficiency by means of such an embodiment. Preferably, a spectral power density of the switching frequency can be reduced by means of the frequency modulation. Preferably, according to a flicker standard, in particular according to DIN EN 61000-3-3 Standard and/or IEC Standard 1000-3-3, flicker can be at least largely, in particular substantially completely, avoided, in particular by an advantageous control of individual induction targets, or a plurality thereof. Moreover, it is possible to avoid a disadvantageous acoustic load on an operator, whereby in particular it is possible to achieve a high level of operating convenience and in particular a positive operating impression for the operator, in particular regarding an acoustic quality. Moreover, the requirements for an EMC filter can be advantageously reduced, whereby material costs can be reduced. By the modulation period being increased relative to the prior art and corresponding to an integer multiple of the half period of the mains AC voltage, a temporary computational effort for carrying out the frequency modulation can also be advantageously reduced. As a result, for many applications of household appliances it is conceivable that an application-specific integrated circuit (ASIC chip) can be replaced by simpler and more cost-effective circuits. Due to the cost savings, in turn users can be advantageously provided with particularly inexpensive household appliance devices with the aforementioned advantageous properties regarding safety and/or convenience.

A “household appliance device”, in particular a “cooking appliance device”, advantageously a “hob device” and particularly advantageously an “induction hob device”, is intended to be understood to mean, in particular, at least a part, in particular a subassembly, of a household appliance, in particular of a cooking appliance, advantageously of a hob and particularly advantageously of an induction hob. Advantageously a household appliance having the household appliance device is, for example, a cooking appliance. A household appliance configured as a cooking appliance could be, for example, an oven and/or a microwave and/or a grill appliance and/or a steam cooking appliance. Preferably, a household appliance configured as a cooking appliance is a hob and particularly preferably an induction hob.

A “control unit” is intended to be understood to mean an electronic unit which is at least partially integrated in the household appliance device and which is provided to control at least one induction target repetitively with a switching frequency and to supply said induction target with energy. Preferably, the control unit for controlling and supplying energy to the at least one induction target has at least one inverter unit which can be configured, in particular, as a resonance inverter and/or a dual half-bridge inverter. The inverter unit preferably comprises at least two switching elements which can be controlled individually by the control unit. A “switching element” is intended to be understood to mean an element which is provided to produce and/or disconnect an electrically conductive connection between two points, in particular contacts, of the switching element. Preferably, the switching element has at least one control contact via which it can be switched. Preferably, the switching element is configured as a semi-conductor switching element, in particular as a transistor, for example as a metal-oxide semi-conductor field effect transistor (MOSFET) or organic field effect transistor (OFET), advantageously as a bipolar transistor with a preferably insulated gate electrode (IGBT). Alternatively, it is conceivable that the switching element is configured as a mechanical and/or electromechanical switching element, in particular as a relay. Preferably, the control unit comprises a computing unit and, in particular in addition to the computing unit, a memory unit comprising at least one control program which is stored therein and which is provided to be executed by the computing unit.

An “induction target” is intended to be understood to mean an inductor or a plurality of inductors which is/are part of the household appliance device and which can be controlled together by the control unit, comprising at least one receiving element which is positioned above the inductor and/or the plurality of inductors and which in particular can be part of an external unit. An “inductor” is intended to be understood to mean in this case an element which has at least one induction coil and which is provided in the operating state to supply energy, in particular in the form of an alternating magnetic field, to the at least one receiving element. In the case of a household appliance device configured as an induction cooking appliance device, an induction target can be provided to supply the receiving element with energy for the purpose of heating. In this case, the receiving element could be configured, for example, as an item of cookware and could have at least one secondary coil as a receiving element for receiving the energy provided by the inductor. Alternatively or additionally, the receiving element could also be configured as a metal heating means, in particular as an at least partially ferromagnetic heating means, for example as a ferromagnetic base of an item of cookware, in which in the operating state eddy currents and/or remagnetization effects, which are converted at least partially into heat, are produced by the inductor. The plurality of inductors can be arranged in a matrix-like manner, wherein the inductors arranged in a matrix-like manner can form a variable cooking surface. Preferably, at least one inverter unit is assigned to each of the induction targets.

Preferably, in the operating state the control unit modulates the switching frequency continuously within an operating period which corresponds at least to a modulation period, preferably a plurality of successive modulation periods. It is conceivable that the operating period of the induction target corresponds to an entire operating duration of the household appliance device, i.e. a time period in which the household appliance device is continuously operated. It is also conceivable that the control unit operates a plurality of induction targets and/or a plurality of inductors of the induction target alternately in a time-multiplex mode. In the time-multiplex mode, the operating period corresponds to the time duration in which the control unit controls without interruption a specific induction target or a plurality of specific induction targets at the same time with the switching frequency and supplies said induction target with energy.

Preferably, for generating an alternating magnetic field and for supplying said induction target with electrical energy, the control unit controls at least one inductor of the induction target with an electrical AC current, the switching frequency thereof preferably ranging from 20 kHz to 150 kHz and particularly preferably ranging from 30 kHz to 75 kHz.

A “modulation period” is intended to be understood to mean a time period in which the control unit modulates the switching frequency by implementing the at least one frequency modulation. The modulation period corresponds to an integer multiple of a half period of a mains AC voltage, wherein the period of the mains AC voltage corresponds to the reciprocal value of the mains frequency. In Europe a mains AC voltage is typically provided at a mains frequency of 50 Hz, so that a half period of the mains AC voltage in this case is 10 ms. In cases in which the household appliance device is supplied with a mains AC voltage at a mains frequency which deviates from 50 Hz, the control unit is provided to adapt the duration of the modulation period to the correspondingly changed period of the mains AC voltage and to select it as a corresponding integer multiple of half of the changed period.

A “frequency modulation” is intended to be understood to mean a modulation method on the basis of which the control unit varies the switching frequency. Preferably, the frequency modulation comprises at least one method which is known by the term “spread spectrum” or “spread spectrum clocking”. The frequency modulation is provided to reduce, preferably to minimize, interferences which in an operating state of the household appliance device can be caused, for example, by individual peaks of the switching frequency. Interferences can be influences which are perceptible by a user and regarded as undesirable and/or influences which are prohibited by legal regulations. For example, interferences could be configured as flicker. Alternatively or additionally, interferences could be undesirable acoustic influences, in particular in a frequency range of between 20 Hz and 20 kHz which is perceptible to an average human ear. Interferences could be caused, in particular, by intermodulations and could be manifested as acoustically perceptible interference noise. “Intermodulations” are intended to be understood to mean sum products or difference products of individual AC frequencies or the n-th harmonics thereof, wherein n is an integer greater than zero. Alternatively or additionally, interferences can also be caused by an occurrence of a ripple current, i.e. an AC current of any frequency and curve shape which is superimposed onto a DC current and manifested as an undesirable humming tone. Interferences in this context do not encompass any technical malfunctions, defects and/or other undesired phenomena, such as for example an uneven heat distribution.

“Provided” is intended to be understood to mean specifically programmed, designed and/or equipped. An object being provided for a specific function is intended to be understood to mean that the object fulfills and/or executes this specific function in at least one use state and/or operating state.

It is further proposed that the modulation period comprises at least two modulation intervals which are, in particular, different from one another and which in each case correspond to an integer multiple of a half period of a mains AC voltage. As a result, a particularly accurate frequency modulation can be advantageously achieved. Preferably, the modulation period comprises a plurality of modulation intervals which, in particular, are different from one another and which in each case correspond to an integer multiple of a half period of a mains AC voltage. It might be conceivable that the at least two modulation intervals correspond to different multiples of the half period of the mains AC voltage. For example, a first modulation interval could correspond to double, and a further modulation interval to the multiple of, the half period of the mains AC voltage. Preferably, all of the modulation intervals within a modulation period in each case correspond to the same multiple of, particularly preferably double, the half period of the mains AC voltage. The modulation intervals can differ from one another, for example, regarding an amount and/or regarding a sign of a variation in the switching frequency. For example, in the first modulation interval the control unit could vary the switching frequency by a specific first amount and in a further modulation interval could vary the switching frequency by a further amount which, for example, is larger or smaller than the first amount and/or has an opposing sign relative to the first amount.

Additionally, it is proposed that in the operating state the control unit modulates the switching frequency using at least one predefined modulation profile. As a result, interferences can be advantageously reduced in a particularly targeted manner. Moreover, a computational effort for the control unit can be advantageously reduced. The predefined modulation profile can be understood to mean in this case a basic temporal progression of the frequency modulation within a modulation period which is stored, in particular, in the memory unit of the control unit. The predefined modulation profile could define, for example, a frequency value range of the switching frequency in which the control unit modulates the switching frequency within the modulation period. For example, the predefined modulation profile could comprise a maximum and/or minimum switching frequency which the control unit cannot exceed or fall below. Alternatively or additionally, the modulation profile could contain, for example, a maximum and/or minimum percentage variation of an initial switching frequency. Additionally, it is conceivable that the modulation profile comprises, in particular, experimentally determined, specific switching frequency values, in particular specific switching frequency values of individual, in particular all, modulation intervals of the modulation period. Preferably, a plurality of different predefined modulation profiles are stored in the memory unit of the control unit, said modulation profiles being able to be automatically recalled by the control unit, in particular on the basis of a selection made by a user of a specific operating mode and/or a set power provided by the induction target. The control unit modulating the switching frequency “using at least one predefined modulation profile” is intended to be understood to mean that the control unit takes into account at least the predefined modulation profile for the frequency modulation. The predefined modulation profile can be provided in this case as a template for the frequency modulation to be carried out by the control unit, wherein the control unit can change the frequency modulation starting from the predefined modulation profile and, in particular, adapt it to an individual operating situation, for example a specific operating mode and/or a number of induction targets to be operated at the same time and/or a set power or the like selected by a user.

The modulation profile could be, for example, a rectangular or saw-tooth-shaped profile and have discontinuous points with larger jumps in the switching frequency. In an advantageous embodiment, it is proposed that the modulation profile is able to be described by a substantially continuous mathematical function. Advantageously, an occurrence of flicker can be reduced, preferably minimized, thereby. Since a change of switching frequencies in electrical components is discrete, and thus cannot take place in infinitesimally small steps, as might be required according to a strict mathematical definition for continuity, in this context the at least substantially continuous modulation profile is intended to be considered as continuous within the context of a resolution of the switching frequency, i.e. a minimum step of the change between two directly successive switching frequencies. Preferably, the minimum step between two directly successive switching frequencies of the modulation profile, which is able to be described by a substantially continuous switching frequency, is at least 1 Hz, advantageously at least 2 Hz, particularly advantageously at least 4 Hz and a maximum of 8 Hz.

It is further proposed that the modulation profile within the modulation period has a path which is linear at least in some portions. Due to the modulation profile which is linear at least in some portions, advantageously interferences can be reduced, preferably minimized, in a particularly reliable manner during operation of the household appliance device, such as for example acoustic interference noise or the like. A “path which is linear at least in some portions” is intended to be understood to mean in this case that the modulation profile has at least a portion consisting of a plurality of at least three successive modulation intervals in which the switching frequency is changed by the control unit, in each case by the same amount. For example, the modulation period could have a portion which consists of at least three successive modulation intervals in which the control unit raises the switching frequency in each case by 1 Hz. The modulation profile can have a plurality of portions which have in each case a linear path, wherein the linear portions could have increases which are different from one another. For example, the control unit could raise the switching frequency in a first linear portion of the modulation profile, consisting of at least three successive modulation intervals, in each of the modulation intervals by 1 Hz, and in a subsequent second linear portion of the modulation profile, consisting of at least three further successive modulation intervals, in each case raise the switching frequency by 2 Hz.

Moreover, it is proposed that the modulation profile within the modulation period has a path which is exponential at least in some portions. Due to a modulation profile which is exponential at least in some portions, advantageously interferences during an operation of the household appliance device such as acoustic interference noise or the like, can be reduced, preferably minimized in a particularly efficient manner. A “path which is exponential at least in some portions” is intended to be understood to mean in this case that the modulation profile has a plurality of at least three successive modulation intervals in which the switching frequency is changed by the control unit in each case by an amount which can be described by an exponential function. For example, the modulation period could have a portion which consists of at least three successive modulation intervals in which the control unit raises the switching frequency in the first of the successive modulation intervals by 2 Hz, in the second of the successive modulation intervals by 4 Hz and in the third of the successive modulation intervals by 8 Hz.

Moreover, it is proposed that the modulation profile within the modulation period is mirror-symmetrical at least in some portions. Advantageously, an occurrence of interferences, in particular flicker, can be further reduced thereby. Further advantageously, a desired set power of the induction target can be set in a particularly accurate manner. The modulation profile which is mirror-symmetrical at least in some portions could have, for example, a first portion in which the switching frequency has a path which is, for example, linear or exponential and which can be described by a first mathematical function, and a second portion which is immediately adjacent to the first portion and which can be described by a second mathematical function which can be represented by reflection on an axis of symmetry.

It is further proposed that the control unit is provided to vary the modulation profile using at least one parameter relating to the induction target. As a result, the frequency modulation can be adapted to an individual operating situation. It is conceivable that the control unit has at least one sensor unit for detecting the parameter relating to the induction target. The parameter relating to the induction target could comprise, for example, a temperature of the induction target and/or a close range of the induction target and/or an operating period of the induction target or the like. In the case of a household appliance device configured as an induction hob device, it would be conceivable, for example, that the control unit varies the modulation profile using a measured temperature in a close range of the induction target, for example on a hob plate. Preferably, the parameter relating to the induction target is an electrical parameter of the induction target and/or at least one component which is connected to the induction target in at least one electrical switching circuit. The electrical parameter relating to the induction target could be, for example, an inductance and/or an electrical resistance and/or an impedance and/or a capacitance and/or electrical voltage and current strength and/or an electrical power and/or a resonance frequency or the like. In an advantageous embodiment, it is proposed that the parameter comprises at least one electrical conductance value of the induction target. As a result, a desired target power of the induction target can be set in a particularly accurate manner. Preferably, the control unit varies the modulation profile such that the electrical conductance value of the induction target is constant, when averaged over the modulation period. The electrical conductance value of the induction target in this case can be a real conductance value and/or a complex conductance value of the induction target.

Moreover, it is proposed that in the operating state the control unit additionally modulates the switching frequency within an intermediate modulation period which corresponds to a maximum of the half period of the mains AC voltage, by means of at least one further frequency modulation. As a result, advantageously an occurrence of interferences, which in particular can be caused by harmonics of an AC current of the supply network, can be reduced and preferably minimized.

The invention is also based on a method for operating a household appliance device, in particular a cooking appliance device, comprising at least one induction target which can be controlled by a switching frequency.

It is proposed that the switching frequency is modulated by means of at least one frequency modulation within a modulation period which corresponds to an integer multiple of a half period of a mains AC voltage. By means of such an embodiment, the household appliance device can be advantageously operated in a particularly efficient manner. Additionally, the household appliance device can advantageously be operated in a particularly safe and/or convenient manner, in particular with low noise and complying with EMC and flicker standards.

The household appliance device is not intended to be limited to the above-described use and embodiment. In particular, for fulfilling a mode of operation described herein the household appliance device can have a number of individual elements, components and units which deviates from a number mentioned herein.

Further advantages emerge from the following description of the drawing. Five exemplary embodiments of the invention are shown in the drawing. The drawing, the description and the claims contain numerous features in combination. The person skilled in the art will also expediently consider the features individually and combine them to form further meaningful combinations.

In the drawing:

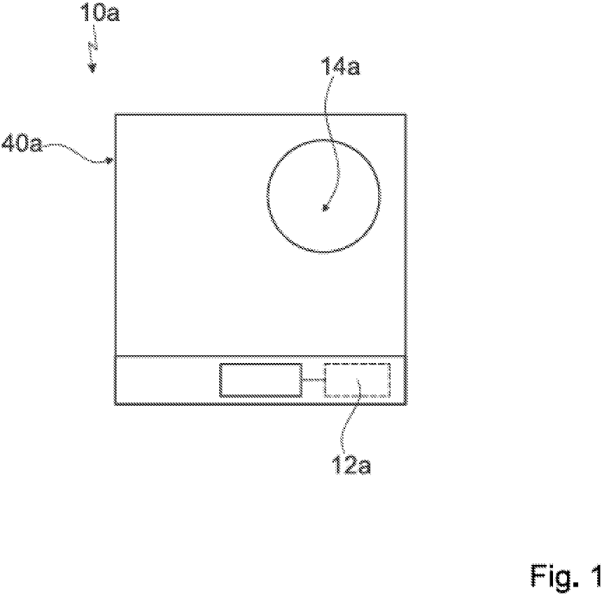

FIG. 1 shows a schematic view of a household appliance comprising a household appliance device comprising an induction target and a control unit;

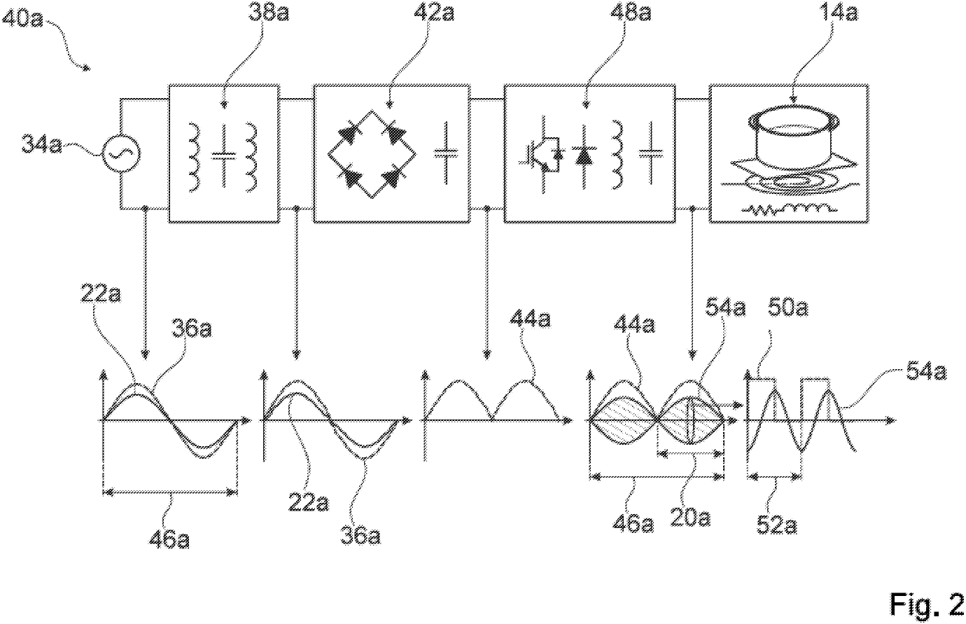

FIG. 2 shows a schematic electrical circuit diagram of the household appliance comprising the household appliance device,

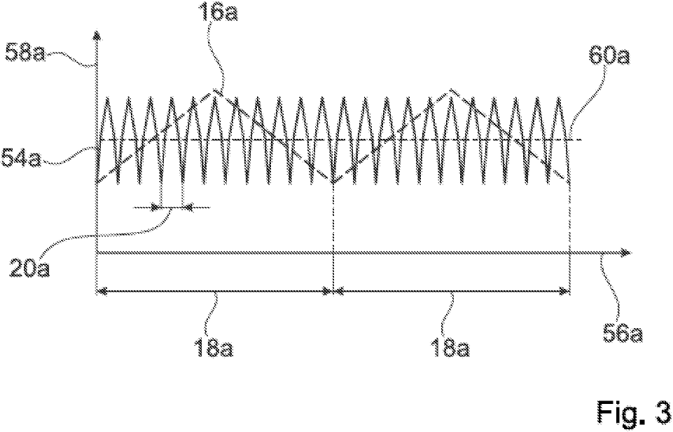

FIG. 3 shows a schematic diagram for showing a modulation period within which the control unit modulates a switching frequency,

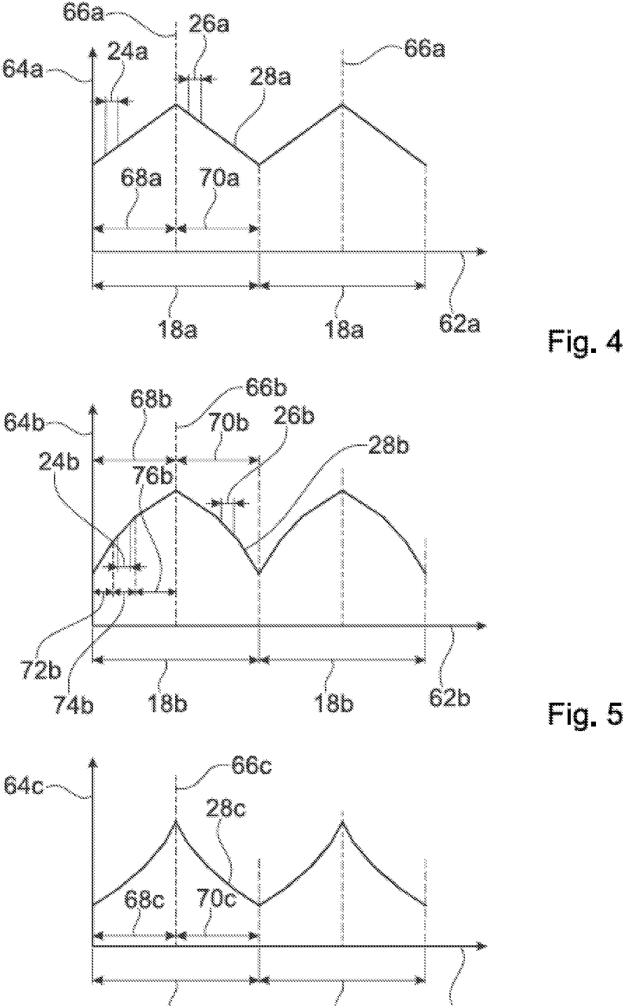

FIG. 4 shows a schematic diagram for showing a modulation profile, the control unit modulating the switching frequency thereby,

FIG. 5 shows a further exemplary embodiment of a modulation profile, a control unit of a household appliance device modulating a switching frequency thereby, in a schematic diagram,

FIG. 6 shows a further exemplary embodiment of a modulation profile, a control unit of a household appliance device modulating a switching frequency thereby, in a schematic diagram,

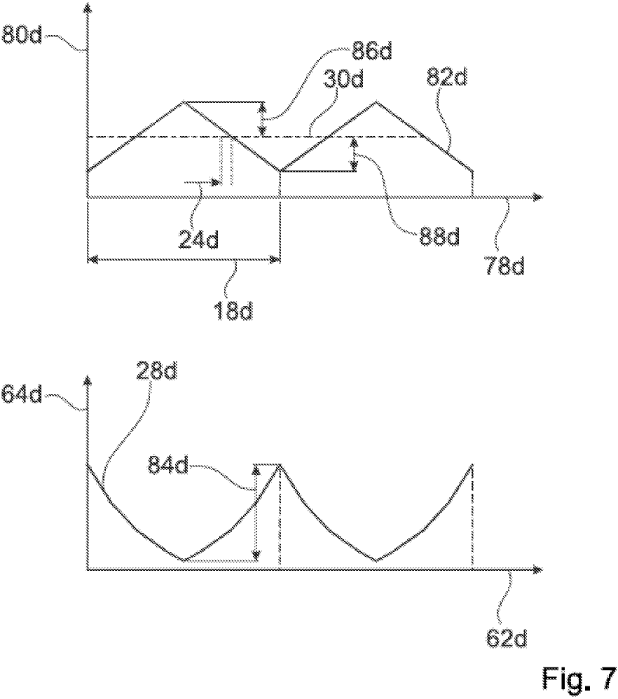

FIG. 7 shows a further exemplary embodiment of a modulation profile, the control unit of a household appliance device modulating a switching frequency thereby, in two schematic diagrams and

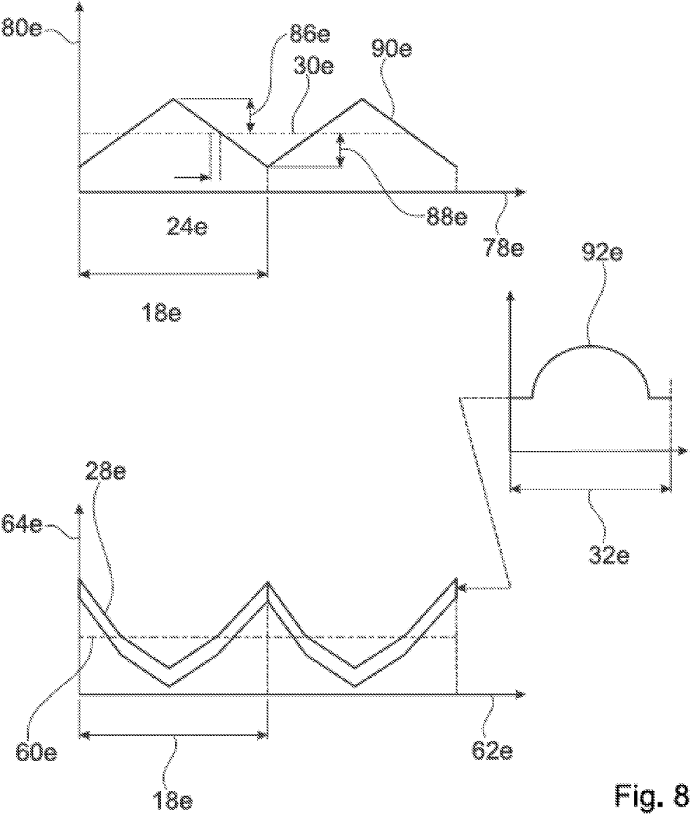

FIG. 8 shows a further exemplary embodiment of a modulation profile, a control unit of a household appliance device modulating a switching frequency thereby, in two schematic diagrams.

FIG. 1 shows a household appliance 40a comprising a household appliance device 10a. The household appliance 40a is configured as an induction hob. The household appliance device 10a has a control unit 12a and an induction target 14a.

The control unit 12a is provided to control the induction target 14a repetitively with a switching frequency 16a (see FIG. 3) and to supply said induction target with energy.

FIG. 2 shows a schematic electrical circuit diagram of the household appliance 40a. The household appliance 40a is connected to a mains AC voltage source 34a. The mains AC voltage source 34a provides a mains AC voltage 22a or a mains AC current 36a with a period 46a. The household appliance 40a has an EMC filter unit 38a which is electrically conductively connected to the mains AC voltage source 34a. The household appliance device has a rectifier unit 42a which is electrically conductively connected via the EMC filter unit 38a to the mains AC voltage source 34a. The rectifier unit 42a is provided to convert the mains AC voltage 22a into a periodically pulsing DC voltage 44a, the period thereof corresponding to a half period 20a of the mains AC voltage 22a.

The control unit 12a is provided to control the induction target 14a repetitively with a switching frequency 16a and to supply said induction target with energy. The control unit 12a comprises an inverter unit 48a. The inverter unit 48a is electrically conductively connected to the rectifier unit 42a of the household appliance 40a. In an operating state of the household appliance device 10a the inverter unit 48a of the control unit 12a converts the AC voltage 44a provided by the rectifier unit 12a of the household appliance 40a within a plurality of successive switching processes, which in each case last for a switching period 52a, into a supply voltage 50a with the switching frequency 16a. In an operating state of the household appliance device 10a the control unit 12a supplies the induction target 14a with electrical energy in the form of a supply current 54a.

In FIG. 3 a diagram is shown for a schematic view of a modulation period 18a. A time is plotted on an X-axis 56a of the diagram. The switching frequency 16a and the supply current 54a are plotted on a Y-axis 58a. In the operating state the control unit 12a modulates the switching frequency 16a within a modulation period 18a by means of a frequency modulation. The modulation period 18a corresponds to an integer multiple of the half period 20a of the mains AC voltage 22a. Averaged over the modulation period 28a the switching frequency 16a corresponds to an average switching frequency 60a.

FIG. 4 shows a diagram for showing a modulation profile 28a within the modulation period 18a. A time is plotted on an X-axis 62a of the diagram. The switching frequency 16a is plotted on a Y-axis 64a.

The modulation period 18a comprises a plurality of successive modulation intervals 24a, 26a which in each case correspond to an integer multiple of the half period 20a of the mains AC voltage 22a. In FIG. 4 two of the modulation intervals 24a, 26a are illustrated by way of example. Within the modulation interval 24a the switching frequency 16a rises. Within the modulation interval 26a the switching frequency 16a falls.

In the operating state the control unit 12a modulates the switching frequency 16a using the predefined modulation profile 28a. The modulation profile 28a is able to be described by a substantially continuous mathematical function. The modulation profile 28a within the modulation period 18a has a path which is linear at least in some portions. Within a first portion 68a of the modulation period 18a, the modulation profile 28a has a linear and substantially continuous path with an increasing switching frequency 16a. Within a second portion 70a the modulation profile 28a has a linear and substantially continuous path with a reducing switching frequency 16a. The modulation profile 28a is mirror-symmetrical in at least some portions. In the present case, the modulation profile 28a is mirror-symmetrical relative to an axis of symmetry 66a so that the path of the modulation profile 28a in the first portion 68a, by reflection on the axis of symmetry 66a, produces the path of the modulation profile 28a in the second portion 70a.

After the elapse of the modulation period 18a this is repeated again and the control unit 12a modulates the switching frequency 16a again using the modulation profile 28a.

In a method for the operation of the household appliance device 10a, the switching frequency 16a is modulated within the modulation period 18a which corresponds to an integer multiple of a half period 20a of the mains AC voltage 22a, by means of the frequency modulation.

Four further exemplary embodiments of the invention are shown in FIGS. 5 to 8. The following descriptions are substantially limited to the differences between the exemplary embodiments, wherein relative to components, features and functions remaining the same, reference can be made to the description of the exemplary embodiment of FIGS. 1 to 4. For differentiating between the exemplary embodiments the letter a in the reference numerals of the exemplary embodiment in FIGS. 1 to 4 is replaced by the letters b to e in the reference numerals of the exemplary embodiments of FIGS. 5 to 8. Relative to components denoted the same, in particular relative to components with the same reference numerals, in principle reference can also be made to the drawings and/or the description of the exemplary embodiment of FIGS. 1 to 4.

FIG. 5 shows a diagram for showing a modulation profile 28b which is used by a control unit 12b of a household appliance device 10b for a frequency modulation of a switching frequency 16b. A time is plotted on an X-axis 62b of the diagram. A switching frequency 16b is plotted on a Y-axis 64b of the diagram.

The household appliance device 10b substantially differs from the household appliance device 10a of the preceding exemplary embodiment regarding the modulation profile 28b used by the control unit 12b for the frequency modulation. In an operating state of the household appliance device 10b, the control unit 12b modulates the switching frequency 16b using the modulation profile 28b by means of the frequency modulation within a modulation period 18b which corresponds to an integer multiple of a half period 20b of a mains AC voltage 22b.

The modulation profile 28b is able to be described by an at least substantially continuous mathematical function. The modulation profile 28b within the modulation period 18b has a path which is linear at least in some portions. Within a first sub-portion 72b of a first portion 68b of the modulation period 18b, the modulation profile 28b has a linear and substantially continuous path with an increasing switching frequency 16b. Within a second sub-portion 74b of the first portion 68b of the modulation period 18b, the modulation profile 28b has a linear and substantially continuous path with a flatter rise in the switching frequency 16b relative to the first sub-portion 72b. Within a third sub-portion 76b of the first portion 68b of the modulation period 18b, the modulation profile 28b has a linear and substantially continuous path with a flatter rise of the switching frequency 16b relative to the second sub-portion 74b.

The modulation profile 28b is mirror-symmetrical at least in some portions. In the present case, the modulation profile 28b is mirror-symmetrical relative to an axis of symmetry 66b so that the path of the modulation profile 28b in the first portion 68b, by reflection on the axis of symmetry 66b, produces a path of the modulation profile 28b in a second portion 70b.

FIG. 6 shows a diagram for showing a modulation profile 28c which is used by a control unit 12c of a household appliance device 10c for a frequency modulation of a switching frequency 16c. A time is plotted on an X-axis 62c of the diagram. A switching frequency 16c is plotted on a Y-axis 64c of the diagram.

The household appliance device 10c substantially differs from the household appliance devices 10a and 10b of the preceding exemplary embodiments regarding the modulation profile 28c used by the control unit 12c for the frequency modulation. In an operating state of the household appliance device 10c, the control unit 12c modulates the switching frequency 16c using the modulation profile 28c by means of the frequency modulation within a modulation period 18c which corresponds to an integer multiple of a half period 20c of a mains AC voltage 22c.

The modulation profile 28c is able to be described by an at least substantially continuous mathematical function. The modulation profile 28c within the modulation period 18c has a path which is exponential at least in some portions. Within a first portion 68c of the modulation period 18c, the modulation profile 28c has a substantially continuous path with an exponentially increasing switching frequency 16b. Within a second portion 70c of the modulation period 18c, the modulation profile 28c has a substantially continuous path with an exponentially reducing switching frequency 16c.

The modulation profile 28c is mirror-symmetrical at least in some portions. In the present case, the modulation profile 28c is mirror-symmetrical relative to an axis of symmetry 66c so that the path of the modulation profile 28c in the first portion 68c, by reflection on the axis of symmetry 66c, produces a path of the modulation profile 28c in a second portion 70c.

FIG. 7 shows two diagrams for showing a modulation profile 28d which is used by a control unit 12d of a household appliance device 10d for a frequency modulation of a switching frequency 16d. A time is plotted on an X-axis 62d of a lower diagram. A switching frequency 16d is plotted on a Y-axis 64d of the lower diagram. A time is plotted on an X-axis 78d of an upper diagram. A power 82d is plotted on a Y-axis 80d of the upper diagram.

The household appliance device 10d substantially differs from the household appliance devices 10a-c of the previous exemplary embodiments regarding the modulation profile 28d used by the control unit 12d for the frequency modulation. In an operating state of the household appliance device 10b, the control unit 12d controls an induction target 14d of the household appliance device 10d with the switching frequency 16d and modulates this switching frequency using the modulation profile 28d by means of the frequency modulation within a modulation period 18d which corresponds to an integer multiple of a half period 20d of a mains AC voltage 22d.

The control unit 12d is provided to vary the modulation profile 28d using at least one parameter 30d relating to the induction target 14d. In the present exemplary embodiment, the parameter 30d relating to the induction target 14d is a target power which is set by a user and which is intended to be provided by the induction target 14d. A general path of the modulation profile 28d is at least substantially continuous, linear in some portions, and can be observed as an inverse of a general path of the modulation profile 28b (see FIG. 5). Using the parameter 30d relating to the induction target 14d, in an operating state the control unit 12d varies a frequency value range 84d of the modulation profile 28d such that the path of the power 82d shown in the upper diagram is produced. Due to the frequency modulation of the switching frequency 16d, the power 82d changes and has in some portions an excess 86d and in some portions a deficit 88d so that when observed over the modulation period 18d the power 82d corresponds on average to the target power set by the user.

FIG. 8 shows two diagrams for showing a modulation profile 28e which is used by a control unit 12e of a household appliance device 10e for a frequency modulation of a switching frequency 16e. A time is plotted on an X-axis 62e of a lower diagram. The switching frequency 16e is plotted on a Y-axis 64e of the lower diagram. A time is plotted on an X-axis 78e of an upper diagram. An electrical conductance value 90e is plotted on a Y-axis 80e of the upper diagram.

The household appliance device 10e differs from the household appliance device 10d of the preceding exemplary embodiment regarding a parameter 30e relating to an induction target 14e which the control unit 12e uses as a basis for a variation of the modulation profile 28e. The parameter 30e comprises at least one electrical conductance value of the induction target 14e. In the present case, the parameter 30e relating to the induction target 14e is an average real conductance value of the induction target 14e. Using the parameter 30e relating to the induction target 14e, in an operating state the control unit 12e varies the modulation profile 28e such that the path of the electrical conductance value 90e shown in the upper diagram is produced. Due to the frequency modulation of the switching frequency 16e the electrical conductance value 90e changes and has in some portions an excess 86e and in some portions a deficit 88e. The control unit 12d varies the modulation profile 28e such that the electrical conductance value 90e on average is constant when observed over the modulation period 18e.

In an operating state of the household appliance device 10e, the control unit 12e controls an induction target 14e of the household appliance device 10e with the switching frequency 16e and modulates this switching frequency using the modulation profile 28e by means of the frequency modulation within a modulation period 18e which corresponds to an integer multiple of a half period 20e of a mains AC voltage 22e.

The household appliance device 10e also differs from the household appliance device 10a-d in that in the operating state the control unit 12e modulates the switching frequency 16e additionally within an intermediate modulation period 32e which corresponds to a maximum of the half period 20e of the mains AC voltage 22e, by means of at least one further frequency modulation. In an operating state, in addition to the above-described frequency modulation using the modulation profile 28e, the control unit 12e varies the switching frequency 16e briefly within the intermediate modulation period 32e and namely within the half period 20e of the mains AC voltage 22e, using the intermediate modulation profile 92e shown in FIG. 8, in order to prevent an occurrence of flicker.

Reference numerals

| | |
|---|---|
| 10 | Household appliance device |
| 12 | Control unit |
| 14 | Induction target |
| 16 | Switching frequency |
| 18 | Modulation period |
| 20 | Half period |
| 22 | Mains AC voltage |
| 24 | Modulation interval |
| 26 | Further modulation interval |
| 28 | Modulation profile |
| 30 | Parameter |
| 32 | Intermediate modulation period |
| 34 | Mains AC voltage source |
| 36 | Mains AC current |
| 38 | EMC filter unit |
| 40 | Household appliance |
| 42 | Rectifier unit |
| 44 | AC voltage |
| 46 | Period |
| 48 | Inverter unit |
| 50 | Supply voltage |
| 52 | Switching period |
| 54 | Supply current |
| 56 | X-axis |
| 58 | Y-axis |
| 60 | Average switching frequency |
| 62 | X-axis |
| 64 | Y-axis |
| 66 | Axis of symmetry |
| 68 | First portion |
| 70 | Second portion |
| 72 | First sub-portion |
| 74 | Second sub-portion |
| 76 | Third sub-portion |
| 78 | X-axis |
| 80 | Y-axis |
| 82 | Power |
| 84 | Frequency value range |
| 86 | Excess |
| 88 | Deficit |
| 90 | Electrical conductance value |
| 92 | Intermediate modulation profile |

1-12. (canceled)

13. A household appliance device, comprising a control unit designed to control an induction target repetitively with a switching frequency and to supply the induction target with energy, said control unit designed to modulate in an operating state through frequency modulation the switching frequency within a modulation period which corresponds to an integer multiple of a half period of a mains AC voltage.

14. The household appliance device of claim 13, constructed in a form of a cooking appliance device.

15. The household appliance device of claim 13, wherein the modulation period comprises at least two modulation intervals which each correspond to an integer multiple of a half period of a mains AC voltage.

16. The household appliance device of claim 15, wherein the at least two modulation intervals are different from one another.

17. The household appliance device of claim 13, wherein in the operating state the control unit modulates the switching frequency using a predefined modulation profile.

18. The household appliance device of claim 17, wherein the modulation profile is able to be described by a substantially continuous mathematical function.

19. The household appliance device of claim 17, wherein the modulation profile within the modulation period has a path which is linear at least in one portion.

20. The household appliance device of claim 17, wherein the modulation profile within the modulation period has a path which is exponential at least in one portion.

21. The household appliance device of claim 17, wherein the modulation profile within the modulation period is mirror-symmetrical at least in one portion.

22. The household appliance device of claim 17, wherein the control unit is designed to vary the modulation profile using a parameter relating to the induction target.

23. The household appliance device of claim 22, wherein the parameter comprises an electrical conductance value of the induction target.

24. The household appliance device of claim 13, wherein in the operating state the control unit additionally modulates through a further frequency modulation the switching frequency within an intermediate modulation period which corresponds to a maximum of the half period of the mains AC voltage.

25. A household appliance comprising a household appliance device, said household appliance device comprising a control unit which designed to control an induction target repetitively with a switching frequency and to supply the induction target with energy, said control unit designed to modulate in an operating state through frequency modulation the switching frequency within a modulation period which corresponds to an integer multiple of a half period of a mains AC voltage.

26. The household appliance of claim 25, wherein the household appliance device is embodied as a cooking appliance device.

27. A method for operating a household appliance device, said method comprising:
controlling an induction target by a switching frequency; and
modulating the switching frequency through frequency modulation within a modulation period which corresponds to an integer multiple of a half period of a mains AC voltage.

28. The method of claim 27 for operating a cooking appliance device as the household appliance device.

29. The method of claim 27, wherein the switching frequency is modulated using a predefined modulation profile.

30. The method of claim 29, further comprising varying the modulation profile using a parameter relating to the induction target.

31. The method of claim 27, wherein the parameter comprises an electrical conductance value of the induction target.

32. The method of claim 27, further comprising additionally modulating through a further frequency modulation the switching frequency within an intermediate modulation period which corresponds to a maximum of the half period of the mains AC voltage.
